(19) United States
(12) Patent Application Publication
(10) Pub. No.: US 2026/0211417 A1
(43) Pub. Date: Jul. 23, 2026

(54) APPARATUS AND METHOD FOR TRACKING OBJECTS

(71) Applicant: JAGUAR LAND ROVER LIMITED, Whitley, Coventry, Warwickshire (GB)

(72) Inventors: Jonathan LLOYD, Whitley, Coventry, Warwickshire (GB); Stefan ARNAUTU, Whitley, Coventry, Warwickshire (GB); Jhonata QUEIROZ, Whitley, Coventry, Warwickshire (GB); Margaret TOOHEY, Whitley, Coventry, Warwickshire (GB)

(21) Appl. No.: 19/140,229

(22) PCT Filed: Dec. 15, 2023
(86) PCT No.: PCT/EP2023/086071

§ 371 Date: Jun. 17, 2025

(30) Foreign Application Priority Data
Dec. 22, 2022 (GB) 2219501.0

(51) Int. Cl. G05D 1/246

(52) U.S. Cl. CPC G05D 1/2464

(57) ABSTRACT

A control system for a vehicle, comprises a controller. The control system is configured to receive sensor data indicative of a location of objects in an environment of the vehicle, determine, depending on the sensor data, an occupancy grid, and a particle filter associated with the occupancy grid, the particle filter maintaining a plurality of particles indicative of a state of the occupancy grid, associate one or more groups of particles within the plurality of particles, wherein each group of associated particles is representative of a perceived object in the environment, maintain one or more tracked objects in the environment depending on the one or more perceived objects, determine a state of each of the one or more tracked objects depending on a respective particle filter associated with each of the one or more tracked objects, and output data indicative of the state of the one or more tracked objects.

### TECHNICAL FIELD

The present disclosure relates to tracking objects in an environment. Aspects of the invention relate to a control system, to a system, to a vehicle, to a method and to computer software.

### BACKGROUND

It is necessary for a robot to determine information about its environment, such as information about objects in the environment. Where the robot is capable of autonomous movement, such as an autonomous vehicle or vehicle having an at least partly autonomous capability, the information about objects is used for navigation to avoid the objects. It is known for an occupancy grid to be used to store information about the environment, such as a location of objects in the environment. The occupancy grid represents the environment of the robot and has a plurality of cells, each representing a portion of the environment and storing an indication of a probability of the occupancy of the respective portion. Sensors associated with the robot, such as the vehicle, provide measurement data indicative of the location of objects and the measurement data is used to update the occupancy grid. In this way, the occupancy grid can be used to track dynamic objects in the environment.

It is desired to improve the tracking of objects in the environment of the robot. The sensors associated with the robot provide the measurement or sensor data from which a location of each object is determined at each detection. However, difficulties may arise in determining which detections in the sensor data correspond to each object, particularly where the objects are dynamic in the environment of the robot. Furthermore, in many cases the robot has a plurality of sensors including sensors of different types. Some sensors provide the sensor data in the form of data indicative of locations corresponding to detections of objects i.e. point cloud sensor data, whilst other sensors comprise processing capability to process the point cloud sensor data determined by the sensor to provide higher-level data representing objects detected in the environment. The higher-level data may be data indicative of tracked objects in the environment. However, it may be difficult to combine the point cloud data provided by one or more first sensors with the higher-level data provided by one or more second sensors.

It is an aim of the present invention to address one or more of the disadvantages associated with the prior art.

It is an aim of the present invention to address one or more of the disadvantages associated with the prior art.

### SUMMARY OF THE INVENTION

Aspects and embodiments of the invention provide a control system, a system, a vehicle, a method and computer software as claimed in the appended claims

According to an aspect of the present invention there is provided a control system for a vehicle, the control system comprising at least one controller, the control system being configured to receive, from at least one sensor, sensor data indicative of a location of objects detected in an environment of the vehicle, determine a perceived object in the environment of the vehicle in dependence on the sensor data, maintain a set of one or more tracked objects in the environment of the vehicle in dependence on the one or more perceived objects, determine a state of each of the one or more tracked objects in dependence on a respective particle filter associated with each of the one or more tracked objects, and output data indicative of the state of the one or more tracked objects. Advantageously the use of a particle filter to represent each tracked object allows efficient tracking of the object.

According to another aspect of the invention, there is provided a control system for a vehicle, the control system comprising at least one controller, the control system being configured to receive, from at least one sensor, sensor data indicative of a location of objects detected in an environment of the vehicle, determine, in dependence on the sensor data, an occupancy grid stored in a memory accessible to the control system, and a particle filter associated with the occupancy grid, the particle filter maintaining a plurality of particles indicative of a state of the occupancy grid, associate one or more groups of particles within the plurality of particles, wherein each group of associated particles is representative of a perceived object in the environment of the vehicle, maintain a set of one or more tracked objects in the environment of the vehicle in dependence on the one or more perceived objects, determine a state of each of the one or more tracked objects in dependence on a respective particle filter associated with each of the one or more tracked objects; and output data indicative of the state of the one or more tracked objects. Advantageously the use of a particle filter to represent each tracked object allows efficient tracking of the object.

The occupancy grid may represent the environment of the vehicle and have a plurality of cells. Advantageously each cell represents a respective region of the environment. The sensor data may be point cloud data indicative of any objects detected in an environment of the vehicle. The point could data may comprise a plurality of points. Each point in the point cloud may be indicative of a location of a detection of an object.

Each perceived object may be associated with one or more of an indication of the object's position, velocity, width and/or length. Advantageously data associated with the perceived object is provided.

The control system is optionally configured to receive, from a sensor system, perceived object data indicative of one or more perceived objects in the environment of the vehicle. Advantageously the control system is arranged to combine or fuse the perceived object data from the sensor system with the perceived object data determined in dependence on the sensor data.

Maintaining the set of one or more tracked objects in the environment of the vehicle is optionally in dependence on the perceived object data. Advantageously the received perceived object data is used to maintain the one or more tracked objects, which may improve the tracking of the objects.

The at least one sensor optionally comprises one or both of a lidar or radar sensor. Advantageously the at least one sensor is useful for determining the location of the object.

The sensor system may comprise a second sensor and a processing module configured to determine the perceived object data in dependence on an output of the second sensor. The processing module may be a perception module or pre-processing module. The perceived object data may be output by the sensor system. Advantageously the sensor system provides the perceived object data which has been subject to initial processing.

The second sensor may comprise a camera. Advantageously the camera may identify visual attributes of objects. The perceived object data is optionally indicative of, for each perceived object, a classification and a location of the respective object in the environment of the vehicle. Advantageously the classification may be indicative of a type of the object.

Optionally the associating the one or more groups of particles comprises determining one or more clusters of particles within the plurality of particles according to one or more predetermined criteria. Advantageously the predetermined criteria may be used to determine whether to associate the particles as a cluster.

The one or more criteria may comprise a maximum distance criteria indicative of a maximum distance between particles to form a respective cluster of particles. Advantageously localised particles may be indicative of an object.

The one or more criteria optionally comprise a minimum particle criteria indicative of a minimum number of particles to form a respective cluster of particles. Advantageously a sufficient number of particles is required to determine an object. The minimum particle criteria may be an epsilon value.

The control system according to any preceding claim, wherein the associating the particles of each of the one or more groups of particles comprises updating an attribute of each of the particles to a shared attribute. Advantageously the shared attribute is used to identify associated particles. The shared attribute may be a shared label. Advantageously the label identifies particles corresponding to an object.

The maintaining the set of one or more tracked objects comprises the control system being configured to determine whether each of the perceived objects corresponds to one of the set of tracked objects or represents a new object. Advantageously it is determined whether th perceived object is already tracked.

The determination optionally utilises an association algorithm. Advantageously the association algorithm allows quantification of whether the perceived object corresponds to a tracked object. The association algorithm may be a Munkres or Hungarian algorithm.

Advantageously the Munkres or Hungarian algorithm are efficient for performing the determination.

The determining the state of each of the one or more tracked objects comprises the control system being configured to predict a state of each of the one or more tracked objects and to combine each tracked object with a respective perceived object. Advantageously the predicted tracked object is combined with the perceived object.

The determining the state of each of the one or more tracked objects optionally comprises the control system being configured to, for at least some of the one or more tracked objects, predict at least one of an occupancy mass and a free mass for each tracked object in dependence on a weight of particles of the particle filter associated with the respective tracked object. Advantageously the occupancy mass and/or free mass is determined in dependence on the particle weights.

Each of the one or more tracked objects may be associated with a bounding box and the control system is configured to predict the at least one of the occupancy mass and the free mass for each tracked object in dependence on the weight of particles of the particle filter within the bounding box. Advantageously the bounding box provides an efficient way to utilise the particle weights.

According to an aspect of the present invention, there is provided a system, comprising a control system according to an aspect described above, and at least one sensor arranged to provide to the control system sensor data indicative of a location of objects detected in an environment of the vehicle to the control system.

The at least one sensor may be arranged to provide sensor data comprising point cloud data indicative of the location of a detection of objects in an environment of the vehicle to the control system.

The at least one sensor optionally comprises one or both of a lidar or radar sensor.

The system may comprise a sensor system arranged to provide perceived object data indicative of one or more perceived objects in the environment of the vehicle to the control system.

The sensor system may comprise a vision system arranged to determine a classification of each perceived object, wherein the perceived object data is indicative of the determined classification.

According to an aspect of the present invention, there is provided a vehicle comprising a control system as described above, or a system as described above.

According to an aspect of the present invention, there is provided a method, comprising receiving, from at least one sensor, sensor data indicative of a location of objects detected in an environment of the vehicle, determining, in dependence on the sensor data, an occupancy grid stored in a memory accessible to the control system, and a particle filter associated with the occupancy grid, the particle filter maintaining a plurality of particles indicative of a state of the occupancy grid, associating one or more groups of particles within the plurality of particles, wherein each group of associated particles is representative of a perceived object in the environment of the vehicle, maintaining a set of one or more tracked objects in the environment of the vehicle in dependence on the one or more perceived objects, and determining a state of each of the one or more tracked objects in dependence on a respective particle filter associated with each of the one or more tracked objects.

The method may comprise receiving, from a sensor, perceived object data indicative of one or more perceived objects in the environment of the vehicle; wherein the maintaining the set of one or more tracked objects in the environment of the vehicle is in dependence on the perceived object data.

The perceived object data may be indicative of, for each perceived object, a classification and a location of the respective object in the environment of the vehicle.

The associating the one or more groups of particles may comprise determining one or more clusters of particles within the plurality of particles according to one or more predetermined criteria.

The one or more criteria may comprise a maximum distance criteria indicative of a maximum distance between particles to form a respective cluster of particles. The one or more criteria may comprise a minimum particle criteria indicative of a minimum number of particles to form a respective cluster of particles.

The associating the particles of each of the one or more groups of particles may comprise updating an attribute of each of the particles to a shared attribute.

The maintaining the set of one or more tracked objects may comprise the control system being configured to determine whether each of the perceived objects corresponds to one of the set of tracked objects or represents a new object.

According to an aspect of the present invention, there is provided computer software which, when executed by a computer, is arranged to perform a method according to an aspect of the invention. Optionally the computer software is stored on a computer readable medium. The computer software may be tangibly stored on the computer readable medium.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a system according to an embodiment of the present invention;

FIG. 2 shows a vehicle according to an embodiment of the present invention;

FIG. 3 shows an illustration of an occupancy grid according to an embodiment of the present invention;

FIG. 4 illustrates a method according to an embodiment of the invention;

FIG. 5 schematically illustrates processing flow in embodiments of the invention;

FIG. 6 illustrates a further method according to an embodiment of the invention;

FIGS. 7a-7e illustrates particles and objects according to an embodiment of the invention;

FIG. 8 illustrates another method according to an embodiment of the invention;

FIGS. 9a-c illustrates assignment matrixes according to embodiments of the invention;

FIG. 10 illustrates fields of view according to embodiments of the invention; and

FIG. 11 illustrates a further method according to an embodiment of the invention.

### DETAILED DESCRIPTION

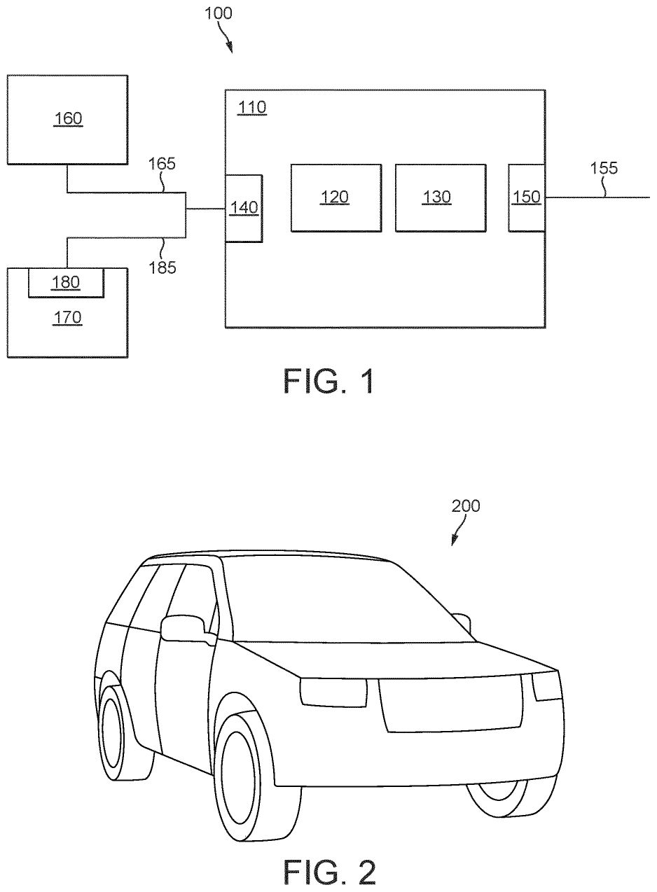

With reference to FIG. 1, there is illustrated a system 100 according to an embodiment of the invention. The system 100 is for use with a robot, such as a vehicle 200 according to an embodiment of the invention as shown in FIG. 2. The vehicle 200 is an example of a robot with an autonomous movement or navigation capability to navigate around an environment in which the robot or vehicle 200 is located. For example, the vehicle 200 may have Level 4 or 5 autonomy capability as defined by SAE International. The vehicle 200 may comprise the system 100 as part of providing such capability. Whilst embodiments of the invention are described with respect to such a vehicle 200 it will be appreciated that embodiments of the invention are not limited in this respect.

The system 100 is arranged to determine an occupancy grid 300 relating to an environment of the vehicle 200. The occupancy grid 300 represents the environment of the vehicle 200 and has a plurality of cells, each representing a portion of the environment and being associated with a probability indicative of the occupancy of the respective portion corresponding to the cell. The occupancy grid 300 is useful for navigating the vehicle 200 within the environment, such as for tracking movement of one or more objects in the environment as will be appreciated.

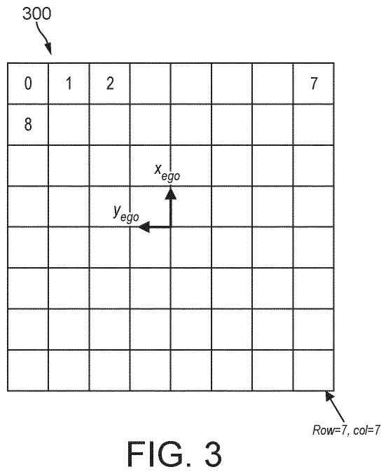

A representation of an example occupancy grid 300 or occupancy grid map 300 is illustrated in FIG. 3. The occupancy grid map 300 and the cells forming part thereof are defined by parameters which define their sizes such that the size and resolution of the occupancy grid map 300 may be chosen for each particular use case. In the example of FIG. 3 the occupancy grid map 300 is 8×8 in size and is thus formed by 64 cells. The occupancy grid map 300 is selected to have a cell size of 1 m×1 m and thus the example square occupancy grid map 300 has sides of length 8 m and represents a 64 m² area of the environment. It will be appreciated that the illustrated occupancy grid map 300 is relatively small for practical application and larger occupancy grid maps are typically used, such as for example, a 120 m×120 m occupancy grid map although embodiments of the invention are not limited in this respect. The occupancy grid map 300 is formed by rows and columns of cells which may each have a corresponding identifying number. In some embodiments cells each have a linear cell index as illustrated which may begin at 0 for a cell in one corner, such as the top-left corner of the occupancy grip map 300 as illustrated. In some embodiments, the vehicle 200 is assumed to be located at a centre of the occupancy grid 300 as indicated by arrows shown. In such embodiments, a relative coordinate space system may be used wherein cells forward of the vehicle are assigned a positive x coordinate value and cells to a left lateral side of the vehicle being associated a positive y coordinate value. Such a coordinate space may be referred to as an EGO relative coordinate space.

The system 100 illustrated in FIG. 1 according to an embodiment of the invention is arranged to output data indicative of the occupancy grip map 300 for use in navigating the vehicle 200. The occupancy grip map 300 is determined in dependence on sensor measurement data indicative of the environment of the vehicle 200 which is provided by one or more sensors of a sensor system associated with the vehicle 200 as will be explained. At least some of the one or more sensors may provide sensor measurement data indicative of a detection of an object whose location corresponds to one or more cells (an object can be determined to correspond to more than one cell) in the occupancy grip map 300.

The system 100 shown in FIG. 1 comprises one or more controller 110. In the illustrated example, the system 100 comprises one controller 110 although it will be appreciated that embodiments of the invention are not limited in this respect. The controller 110 is arranged to, in use, output data 155 in dependence on the occupancy grip map 300. The controller 110 is arranged in some embodiments to output data 155 indicative of a state of one or more objects denoted in the occupancy grid map 300 as will be explained.

Each controller 110 may comprise a respective processing means 120, such as an electronic processing device 120 or computer processor, hereinafter processor 120. The processor 120 is arranged to operably execute computer-readable instructions which may be stored in a memory means 130 formed by one or more memory devices 130 forming a memory 130 which is communicatively coupled to the processing device 120. The controller 120 comprises an input means 140 and an output means 150. The input means 140 may comprise an electrical input 140 of the controller 110 The output means 150 may comprise an electrical output 150 of the controller 110. In some embodiments, the input means 140 and output means 150 may be unified such as in the form of a network interface which inputs and outputs data, for example to a communication bus of the vehicle 200. The controller 110 may therefore receive data from the communication bus and output data onto the communication bus. In some embodiments, the input means 140 is arranged to receive sensor measurement data 165,185 from one or more sensors 160, 170 associated with the vehicle 200. In the example, the system 100 comprises first 160 and second 170 sensors although it will be appreciated that this merely an example and the system is not limited to use with two sensors.

The first sensor 160 is of a first type. The first type of sensor may emit radiation, such as from a laser, and receive radiation reflected from an object, such as via a detector e.g. photodiode or similar. The reflected radiation is used to determine a point location corresponding to the object i.e. point data, wherein a collection of points each corresponding to reflections of radiation form a point cloud. Each point data may comprise data indicative of a location, such as in three dimensions i.e. x, y, z, of the detected object. The first sensor 160 provides the point data to the controller 110 as first sensor measurement data 165. The first sensor 160 may be, for example, a lidar or radar sensor.

The second sensor 170 is of a second type which comprises processing capability provided by a pre-processor 180 to act upon or process its generated data, such as sensor measurement or image data. The second sensor 170 may be a vision device such as a camera. The second sensor measurement data 185 output by the pre-processor 180 of the second sensor 180 comprises object data 185 indicative of one or more characteristics of a detected object i.e. at a higher level than merely being indicative of the detection of the object. For example, the object data 185 may comprise one or more of an indication of an object's position, velocity, height, width, length classification e.g. type of object etc, in addition to its location which may be a location, in three dimensions i.e. X, y, z. The second sensor 170 provides the object data 185 to the controller 110.

The processor 120 is arranged to store in the memory 130 data indicative of the occupancy grip map 300. The processor 120 is arranged to update or modify the occupancy grip map 300 based on the incoming sensor measurement data 165, 185. Fusing of incoming sensor measurement data 165, 185 with the occupancy grid map 300 may be performed by a dynamic occupancy grid map (DOGMa) process. The DOGMa process 300 may be performed at a periodic time interval based on the received sensor measurement data 165, 185. A time interval variable may be used to represent the time between iterations or cycles of a DOGMa process as explained below in connection with block 410. The DOGMa process provides a method of fusing sensor data in the dynamic occupancy grid map. The DOGMa process is explained more in a PHD Thesis by D. Nuss, “A Random Finite Set Approach for Dynamic Occupancy Grid Maps”, 2018 also published in The International Journal of Robotics Research, which are herein incorporated by reference.

Embodiments of the present invention are described connection with the DOGMa process. However it will be understood that other processes, such as using a direct association of cells to track level fusion or Bayesian Occupancy filters, may be used for updating or modifying an occupancy grid map 300 and the usefulness of embodiments of the present invention are not limited to the DOGMa process.

As will be explained, a particle filter (first particle filter) is used to model a state of the occupancy grid map 300. The particle filter maintains a list of particle states, one or more weights and indices of cells of the occupancy grid map 300 to which the particles belong. A label may be assigned to each particle as an identifier for an object (if any) to which the particle is associated. The label acts as an identifier for an untracked object to which the particle is associated. A next state of the particles is predicted and are updated by detections of objects in the sensor measurement data 165, 185 as will be explained.

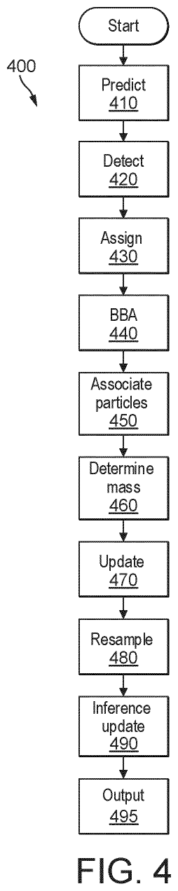

A method 400 according to an embodiment of the present invention is explained with reference to FIG. 4. The method 400 may be performed by the processor 120 and instructions representing the method 400 may be stored in the memory 130 as computer readable instructions.

When particles used in the method 400 are initialised, such as prior to the method 400 commencing, particles used in the method 400 are created and stored in a data structure, such as a matrix, which may be a 1*N matrix where Nis the number of particles. The particles may be initially distributed randomly around the occupancy grid map 300. Each particle is associated with a label having an initial value, which may be a value indicating that the particle is unassigned. In one embodiment the unassigned label is ‘−1’ with it being appreciated that other labels may be used. In one embodiment, a positive integer is indicative of the particle being associated with an object.

When new particles are created during block 480 which is a resampling step of the method 400 they are initially un-associated and adopt the corresponding label, such as ‘−1’. New particles may be created at any location within a cell of the occupancy grip map 300 i.e. distributed around the cell and may have random velocities.

In block 410 a prediction operation is performed. The prediction operation predicts a new location for particles and updates the cells of the occupancy grip map 300 with which the particles are associated accordingly.

In some embodiments, for the purpose of the prediction operation in block 410, a transition matrix is created using a time_step variable indicative of the periodic time interval between cycles of the method 400 updating or modifying the occupancy grid map 300. A noise generation function may be used to create a process_noise matrix that is used to model uncertainty in the particle predictions. This may be performed by using a randomly generated matrix with a configurable i.e. selected standard deviation.

In the particle prediction of block 410, the state of the particles used in the DOGMa process are predicted. The state may be represented with position and velocity, such as: x,y, vx, vy. For reasons of computational complexity, in some embodiments a two dimensional world is used in which the z axis is not modelled. The state prediction may be performed by matrix multiplication between a current state and the transition matrix. In some embodiments, the process_noise matrix is added to the result of the multiplication to introduce uncertainty. Some particles close to the edge of the occupancy grip map 300 grid will be predicted to leave the bounds of the occupancy grid map 300 when their velocity takes them over the boundary at the next time step. These particles are removed from the DOGMa process.

The weight of each particle may be degraded whenever a prediction is carried out in block 410. The degrading may be performed by a multiplication of a weights matrix and a persistence_probability variable. The weights matrix is a matrix which may be used in some embodiments to store a weight associated with each particle. The weights matrix may be a 1×N matrix or vector, where N is the number of particles. The persistence_probability is a parameter that controls the longevity of particles in the DOGMa process. The persistence_probability may have a value of between 0.0-1.0, wherein 0.0 means the particle will not persist and 1.0 meaning the particle weight will never degrade. Thus a value between 0 and 1 is usually chosen. As a result of the prediction operation in block 410 each particle has an updated or predicted location and velocity. As the particles have moved, the cell index of the occupancy grid map 300 to which they are each assigned is updated. The updating of cell indexes may be performed by mapping the x,y state indicative of the location of each particle to the location of the cell of the occupancy grid map 300 to which it belongs.

Cell occupancy may use Basic Belief Assignment (BBA) from Dempster-Schafer Theory, as will be appreciated by the skilled person. At a basic level for the DOGMa process, this means that a variable predicted_occupancy_mass may be maintained, that represents the likelihood that a cell of the occupancy grid map 300 is occupied, and predicted_free_mass, that represents the likelihood that the cell of the occupancy grid map 300 is unoccupied or free. Here these masses may be determined in block 410 for each cell of the occupancy grip map 300 using the weights of particles, such as stored in the weights matrix, assigned to each respective cell. This BBA is then stored as a prior mass or prior BBA, which is used subsequently to determine a posterior calculated mass or posterior BBA, as will be explained. In other words, the prior BBA is prior to receiving measurements and the posterior BBA is as updated during an iteration of the method 400.

In block 420 any objects in the environment of the vehicle 200 are detected for example by the first sensor 160 associated with the vehicle 200. As discussed above the first sensor 160 outputs sensor measurement data 165 indicative of any detected objects, where the sensor measurement data 165 is received by the controller 110. In some embodiments, the sensor measurement data 165 is formed into a measurement grid map as discussed below. In some embodiments the measurement grid map is another grid map which may match the dimensions of the DOGMa occupancy grid map 300 i.e. in the example the measurement grid map 300 may be 8×8 cells as in FIG. 3, although it will be appreciated that other sizes of measurement grip map may be used.

In block 430 the detections of any objects indicated in the sensor measurement data 165 received in block 420 are mapped onto the measurement grid map and assigned to cells of the measurement grid map. That is, the detections are assigned to the measurement grid map cells. As discussed above, the detections of objects in the first sensor measurement data 165 are provided as a point cloud. The point cloud comprises point data indicative of locations at which an object is detected by the first sensor 160. The points in the point cloud have associated x,y,z positions. The occupancy grip map 300 may be, especially for a land-going robot or vehicle, 2D i.e. lacking in dimension z. Therefore, the points in the point cloud may be flattened. As part of the flattening, points with z axis values that are outside of a region-of-interest associated with the vehicle may be removed e.g. a point detected 20 meters above the EGO vehicle does not form part of the measurement grid map 300. The flattened points are then mapped or assigned to cells of the measurement grip map in block 430.

In block 440, cell occupancy probability is determined for the cells of the measurement grid map 300. Each cell of the measurement grid map 300 is associated with one or both of an occupied mass and a free mass as xxxx above. In some embodiments, each cell of the measurement grid map, and also the occupancy grid map, is associated with a value indicative of an occupied mass and a value indicative of a free mass of the respective cell. The occupied mass is a probability or belief of the cell being occupied by an object and the free mass is a probability of the cell being free or unoccupied. Based on these mass values, a value indicative of an unknown mass or probability may be determined as a difference between the two mass values.

In some embodiments, a detection of an object in a cell raises the occupied mass of one or more adjacent cells. In some embodiments, a 2D Gaussian Kernel is created which allows the detection in one cell of the measurement grid map to raise the occupied mass of adjacent cells. The Gaussian Kernel generates a matrix where the values inside the cells of the matrix correspond to a Gaussian distribution with mean 0 and standard deviation given by a sigma parameter. The occupied mass of each cell of the measurement grid map may be initialised to all be zero, then a list of cells that contain detections from block 420 is used to generate beliefs for each cell to be occupied. In some embodiments, the beliefs may be generated by using matrix convolution of the Gaussian Kernel applied to the measurement grid map. A vector of occupied mass is produced which is used to generate the cell occupancy BBA as described above with respect to the occupancy grid map. The Dempster-Schafer Rule of Combination may be used where cell mass is updated or modified multiple times, for example when a cell is adjacent to two detections, or when multiple detections are in one cell. As a result of block 440, in some embodiments each cell of the measurement grid is associated with a variable occupancy_mass which represents the likelihood that the respective cell of the measurement grid map 300 is occupied, and free_mass which represents the likelihood of the respective cell being empty or free. In other embodiments, each cell may be associated with a data structure such as occupancy_bba which contains values corresponding to the occupancy_mass and the free_mass.

In block 450 of the method 400 one or more particles are associated with the measurement grid map. In some embodiments, a data structure particle_association_info is associated with the measurement grid map. This data structure stores a probability for each cell for particles in that cell being associated with a measurement of an object. In some embodiments, the probability y is determined with a probability density function according to a Normal Gaussian distribution, although it will be appreciated that other distributions may be used. The function may be:

$$Y = \frac{1}{S \sqrt{( 2 π )}} exp ( - 0.5 \frac{{( x - m )}^{2}}{{s}^{2}} )$$

Where y is indicative of the probability of a cell, and therefore any particles within the cell, being associated with a measurement of an object, mean (m) may be 0, sigma(s) may be 1 and x is the distance in meters from the cell to the detection of the object. Thus, for particles in each cell, the probability y of the particles being associated with a detection is determined in block 450.

In block 460 one or more components of particles are determined. The particles for which the one or more components are determined in block 460 may be newly born particles and persistent particles in the posterior belief i.e. posterior BBA.

In some embodiments, the one or more components, which may be represented as occupied_mass_components are determined using the occupied_mass from the determined measurement grid map, the prior_occupied_mass from DOGMa Grid as determined in the prediction of block 410 and a birth_probability parameter. The occupied_mass_components represents the components of newly born particles, which are used in resampled block 480 below, and the components of persistent particles which are used in an update block 475 below. The birth_factor parameter controls a balance of newly created particles versus persistent particles. The birth_factor parameter may assume a value in a predetermined range such as 0-1. The higher the value the less likely particles are to persist between time steps, thereby controlling how sensitive the method 400 is to incoming detections. A value of 0 means no new particles are created, whereas a value of 1 means that particles will be created directly relative to the occupied mass. A greater number of new particles being created results in a greater number of existing particles being pruned in the resample block 480. As an example, the birth probability may be around 0.02, although other values may be chosen. The function below returns a set of persistent particles (pers_mass) to use in the update block 470 below, and a set of particles to be created to use in the resample block 480 (born_mass).

$$\begin{matrix}scaled\_free \_plausibility = birth\_factor * ( 1 - prior\_occupied \_mass ) \\ born\_mass = \frac{( occupied\_mass \cdot scaled\_free \_plausibility )}{( prior\_occupied \_mass + scaled\_free \_plausability )}\end{matrix}$$

Please note occupied_mass and scaled_free_plausibility are vectors multiplied with Schur product. The scaled_free_plausability variable has a purpose of reducing a probability of particles being born.

Where pers_mass may be calculated as:

$$pers\_mass = occupied\_mass - born\_mass$$

The persistent mass pers_mass is a remainder of the born mass being deducted from the occupied mass. Please note that the operations above are element wise vector operations.

Block 470 is the update block. In block 470, cells and particles in the dynamic occupancy grid map are updated or modified with the detections incorporated into the measurement grid map . . .

For use in the particle update, a function likelihood may be defined that calculates the Doppler measurement likelihood according to the method from DOGMa Thesis (Nuss, 2017) (equation 5.70 and 5.71 pp. 77). In essence, the update operation in block 470 is a determination of the likelihood of a particle existing relative to an incoming measurement. i.e. if a particle is close to the measurement, and has a similar velocity, then the particle will be given a greater weight.

Block 470 may comprise cell occupancy and particle updating processes. The cell occupancy is updated in block 470 by updating the posterior BBA with the BBA from the measurement grid map and the prior BBA. As described above, the updating may be performed using the Dempster-Schafer Rule of Combination for the occupied and free masses.

In block 470 particle weights are updated. A function to update particle weights is used in some embodiments which carries out a vector multiplication between existing, un-normalised, weights of the particles and the Doppler measurement likelihood that is referred to above. Updating particles in this way degrades the particle weights depending on how much their states differ from the incoming detection.

A normalisation factor may be used in some embodiments for each cell to normalise the weights of particles that are within each cell. Such normalisation is done separately for associated (associated with a detection) and un-associated cells. With associated cells, the persistence mass for a cell may be divided by the sum of the particle weight in that cell. Persistence mass is relative to the incoming detections in the measurement grid map, where the persistence mass is calculated in block 460 above. This is carried out for every cell in the measurement grid map. In effect, this process increases particle weights for particles that are at, or close to, incoming detections from the sensor 160. Un-associated cells may be updated by dividing the persistence mass by the prior occupied mass. The un-associated and associated weight normalisation factors are updated in this way. These are vectors with entries for each cell.

In some embodiments, normalisation may be carried out on the weights vector. The normalisation may use the unnormalised_weights for each particle, associated_particles_normalisation_factors for each cell, unassociated_particles_normalisation_factors for each cell and the association_prob from the measurement grid map. This step of block 470 determines a probability for each cell for particles in the cell to be associated with a measurement. Each particle has a probability of being associated and of being un-associated, which in added together may form the weight of the particle in some embodiments.

An association part may be calculated by the association probability of the cell multiplied by the associated particles normalisation factor and the un-normalised weight of the particle.
associated_part=association_prob*associated_particles_normalisation_factors (cell)*unnormalised_weights (particle);

An un-associated part may be calculated as:

$$unassociated\_part = ( 1 - association\_prob ) * unassociated\_particles \_normalisation \_factors ( cell ) * weights ( particle ) ;$$

The above process may be carried out for every particle.

In block 480 a resampling operation is performed. During the resampling operation, new particles are initialised, which may be according to the born mass discussed above, and other existing particles are pruned. In block 480 the new particles are not initially associated with objects. Those new particles may have a label indicative of not being associated with an object, such as ‘-1’ in some embodiments although other labels may be used. As mentioned above, pruning may performed to maintain the total number of particles in the dynamic grid map at a defined num_particles parameter which provides a desired number of particles for the grid map. After new particles are born, the total number of particles is num_particles+number_of_birth_particles where number_of_birth_particles defines the number of born particles. Pruning is used to reduce the number of particles to num_particles. In some embodiments, the pruning may comprise generating a number of uniformly distributed random numbers. The distribution of random numbers will be of size num_particles to index particles in the total number of particles. These are the particles that will persist, with the rest being pruned, thereby maintaining the number of particles at num_particles.

In some embodiments, a sampler function is used. The sampler function is a function to assist in performing weighted random sampling. Use of the function is modular in that different sampler functions can be used in block 480. In one embodiment a discrete distribution is used which returns random numbers where the probability of integer/is defined as:

$$I = \frac{{w}_{i}}{S}$$

Where wᵢ is the weight of the i-th integer divided by the sum S of all n weights where n is the number of weights. It may be considered that the random sampler has a greater likelihood of retaining particles having a higher weight.

New particles may be created during the resampling operation in block 480. In some embodiments, the creating of particles may be controlled by parameters new_particles_per_cell: the number of new particles that should be created in each cell, proportional to the born_mass, wherein:
born_mass: for each cell, the component of the posterior occupied mass for new particles.
probability_for_cell: This contains the probability for each cell for particles in that cell to be associated with a measurement.
max_velocity: Maximum velocity to be used for newly initialised particles in meters per second.

A particle creation function in some embodiments is used which returns a pair where the ‘first’ member is a N×4 matrix, where N is the total number of new particles, of particles states as [x y vx vy], and a ‘second’ member is a N×1 vector of particle weights.

New particles may be instantiated in a cell where the higher the born_mass the larger number of particles will be created. Since born_mass is relative to incoming detections, this results in more particles created around incoming detections. These particles are created with a position and velocity strategy. The strategy may comprise instantiating particles with a distribution, such as a standard random distribution, inside a cell. Advantageously, particles are not all created at the centre of a grid cell, but distributed randomly around the cell with random velocities. In some embodiments, all new particles are un-associated, so they are instantiated with a label ID that represents un-associated, such as −1 although other labels may be used.

The creation of new particles may provide a vector of new particles. New particles may be appended to existing particles. In some embodiments, the created joint vector of particles is resampled, such as using the sampler function noted above. In this way, new particles are created for the particle filter and, at the same time, low-weight particles are pruned so that the total number of particles is maintained at the defined limit.

In block 490, labels associated with particles are updated to represent objects. The particles may be clustered using a clustering algorithm. An example of a clustering algorithm which may be used in block 490 is the DBSCAN algorithm (Ester, et al., 1996), although other methods of clustering particles may be used. Particularly may be clustered according to one or more predetermined criteria. The clustering creates clusters of particles with the same label. A cluster of particles will represent a perceived object within an environment of the vehicle. The cluster of particles having the same label may be extracted to an untracked object having one or more characteristics. The one or more characteristics may include one or more of a centre point, velocity and bounding box. The clustering algorithm will associated groups of particles as an object. A configurable min_points variable may be used to determine a minimum number of particles that need to be in a cluster for it to be considered an object. In some embodiments an epsilon variable is used to configure a distance allowable between particles to be considered part of the cluster. A cluster of particles may therefore represent a perceived object in the environment of the vehicle. A data structure may be used to represent the perceived object, the data structure storing one or more attributes such as one or all of a location of the object, width, length, etc. Perceived object data indicative of one or more perceived objects is output in block 459

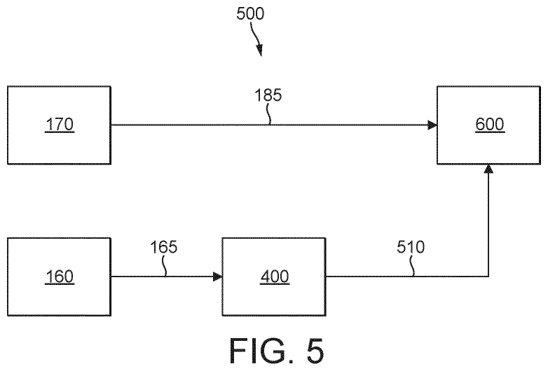

Object extraction in block 490 allows the production of untracked objects which are then output in block 495 to an Object Level Tracker (OLT) 600 (shown in FIG. 5) as another sensor input to be fused with data from other sensors 170, such as camera and radar sensors. In the example, the untracked objects determined in block 490 may be combined with the second sensor measurement data 185. Advantageously, since the untracked objects determined in block 490 are fairly simple, e.g. they lack any classification detail, they can be fused with data from other sensors, such as the second sensor 170, that allows high quality classification to be provided, such as camera/Lidar, and to improve the position and velocity estimates of those sensors.

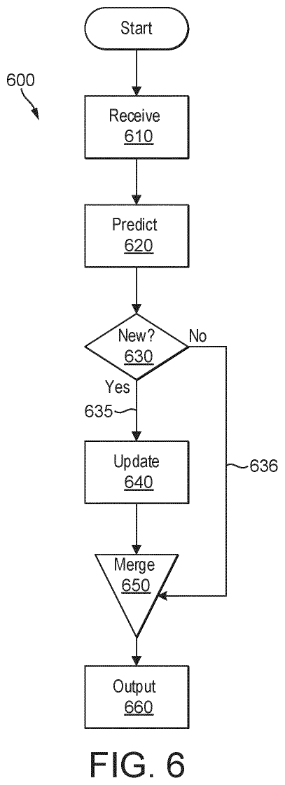

In block 495 one or both of an occupancy grid map 300 having a probability of occupancy for each cell and a data structure containing one or more i.e. a list of untracked objects extracted from the occupancy grid map 300 is output. These are provided to the OLT 600 which is arranged to fuse or combine data from multiple sensors, such as the sensors 160, 170 shown in FIG. 1. As described above, the method 400 of FIG. 4 operates in block 400 of FIG. 5 on data from the first sensor 160. Block 400 outputs data indicative of untracked objects as described above. The second sensor 170 outputs object data 185 indicative of one or more characteristics of a detected object i.e. at a higher level than merely being indicative of the detection of the object. The second sensor data is often indicative of a classification or type of the object determined from the second sensor 170 being vision-based. Block 600 provides the OLT 600 or object fusion to fuse or combine the untracked objects 510 from block 400 and the object data 185 from the second sensor 170. Block 600 implements a method 600 according to an embodiment of the invention illustrated in FIG. 6.

FIG. 6 illustrates a method 600 of fusing or combining object data from multiple sources such as multiple sensors 160, 170, in particular sensors providing object data having different levels of object interpretation. The method 600 is performed by the OLT 600. In some embodiments the OLT 600 provides association, tracking and state estimation on the data from the multiple sensors 160, 170 as will be explained.

The OLT 600 utilises a data store which stores information about tracked objects i.e. objects currently being tracked. The OLT 600 further comprises a state estimator for each tracked object indicative of an estimate of the respective object's state. In embodiments of the present invention the state estimator is a particle filter associated with each tracked object. Thus a respective particle filler is associated with each tracked object.

As discussed above, the method 600 of FIG. 6 receives data indicative of detected objects from two or more sources to fuse or combine that data. Thus block 610 of the method 600 comprises receiving 610 said data indicative of any perceived objects in the environment of the vehicle 200 at a time of execution of block 610 i.e. it will be appreciated that at some times no objects will have been detected and thus no data is received in block 610. A first input is from block 495, as discussed above, in dependence on the first sensor 160 measurement data 165. The output of block 495 is data indicative of detected or perceived objects comprising first information such as one or more of length, width, position i.e location and velocity of the perceived object. Data received from another source i.e. second sensor 170 is object data indicative of perceived objects having more information than from block 495, such as data indicative of a type or classification of the perceived object which may be determined in dependence on visual information captured by the second sensor 170, such as a camera. However, for example, positional information from the second sensor 170 may be less accurate than that from the first sensor 160 which may emit radiation to accurately determine the location of the perceived object. Therefore combining or fusing the data from both sources or sensors 160, 170 is advantageous. In some embodiments, the same type of data structure i.e. indicative of a detection of a perceived object may be received from block 495 and from the second sensor 170 but with varying or different information content i.e. some fields of the data structure may be null or empty.

In some embodiments, the method 600 is performed at periodic intervals i.e. an iteration of the method is performed at predetermined time intervals. Some blocks 600 of the method are performed in dependence on there being new detections of perceived objects as will be explained. Those blocks may be performed for a detection from one of block 495 or the second sensor 170. For example, block 640 may be performed for a detection from block 495 and then for a detection from the second sensor 170. In this way, problems associated with sensors 160, 170 detecting a new object and all or both being determined to be a new, different, object may be minimised. Since the method 600 is performed in some embodiments periodically, when the detection from e.g. the second sensor 170 is processed it will be recognised as the same object as from the first sensor 160 output by block 495.

Block 620 is a prediction step. Block 620 aims to determine an estimate of a current location of an object. As noted above, the method 600 may be performed periodically e.g. at periodic time intervals. Thus a time interval variable may be utilised to indicate the time between performances of block 620. Since each object is associated with a confidence value, the confidence value may be modified in block 620. The confidence value associated with an object may be reduced or degraded by a predetermined amount each time interval or time step in the absence of any detections associated with an object. Similarly, where a track is created for a newly detected object, it may be associated with a relatively low confidence value which is increased every time step for which the object is detected. In block 620 the prediction of an object's location is based upon its associated velocity and the time interval to determine a distance by which the object has moved to provide a prediction of the current location of the object at the present time.

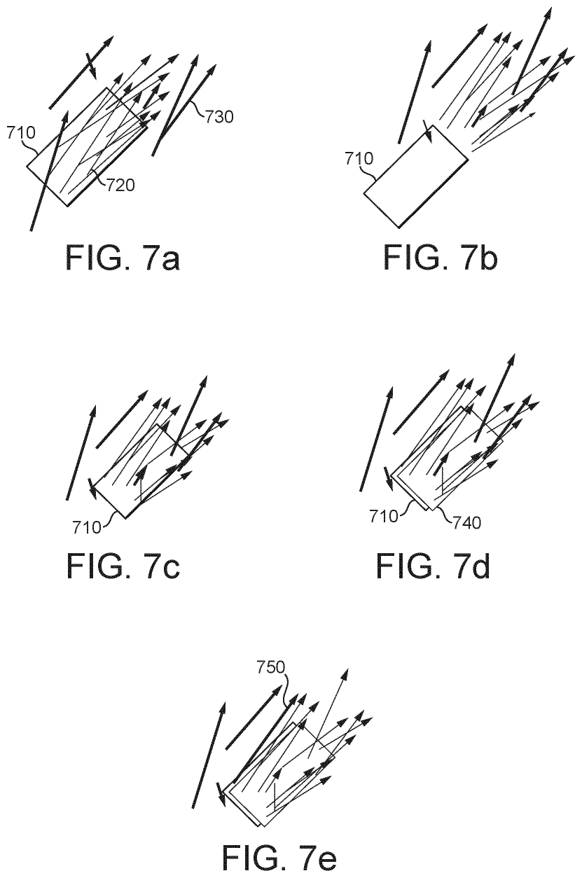

FIG. 7a illustrates a state of an example object 710 indicated with a bounding box having associated 720 and un-associated 730 particles. This is the state of the object at a time of a last performance of the method 600 i.e. at a current time minus the time interval between executions of the method 600. It is therefore necessary to predict the current state of the object 710 i.e. a state at a time of current execution of the method 600.

A current location of each particle 720, 730 is determined in dependence on the time interval and an associated velocity of each particle 720, 730. In some embodiments, randomness may be introduced into the determination, such as by using a noise generation function. A process_noise matrix may be generated by the noise generation function to model uncertainty which may use a configurable i.e. selected standard deviation, as described above in connection with block 410. FIG. 7b illustrates the object 710 with the particles 720, 730 at their respective determined current locations, in comparison to those in FIG. 7a.

In some embodiments of block 620 a transition matrix is used having a time_step variable indicative of the periodic time interval between cycles of the method 600. As also described above, in some embodiments a variable persistence_probability controls the longevity of particles. Furthermore in block 620 a weight of each particle may be degraded. The persistence_probability may have a value in some embodiments of between 0.0-1.0, wherein 0.0 means the particle will not persist and 1.0 meaning the particle weight will never degrade. The state, such as position (x,y), velocity (vx, vy), of particles is thus predicted in block 620.

Once the current location of the particles 720, 730 is predicted, the location of the corresponding object 710 is predicted in dependence on the updated locations of the associated particles 720. FIG. 7c illustrates the updated location of the object 710.

In some embodiments, a predetermined location of the object 710, such as its centrepoint, is determined in dependence on the predicted location of the associated particles 720. An average location of the associated particles 720 may be used, or in some embodiments a weighted average. Similarly, a velocity of the object 720 may be determined in dependence on the velocities of the associated particles 720. In some embodiments, a geometry, such as one or both of a length and width, of the object may be predicted in block 620. In one embodiment each dimension may be updated in dependence on a distance of a furthest associated particle 720 having at least a threshold weight from the centre-point of the object 710.

In block 630 it is determined whether data indicative of detections of any new objects has been received in block 610. If data indicative of no new perceived objects was received in block 610, the method follows 636 to block 650. If data indicative of one or more perceived objects was received in block 630 the method 600 follows 635 to block 640. Thus block 640 is performed in dependence on a detection of at least one perceived object being received in that iteration of the method 600.

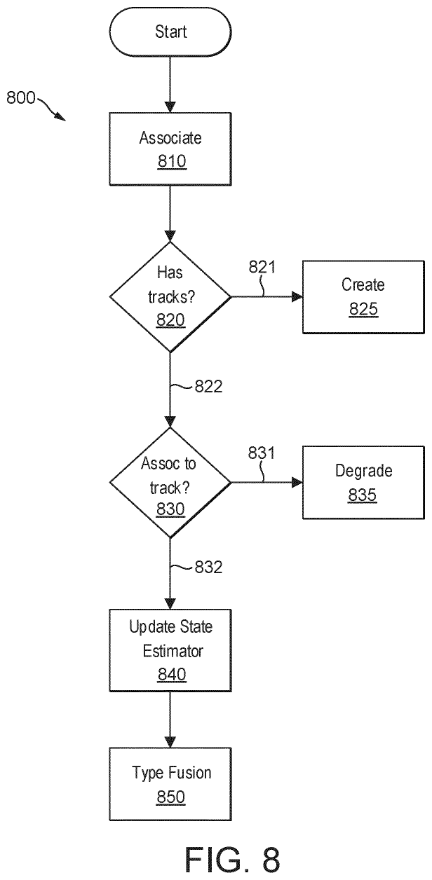

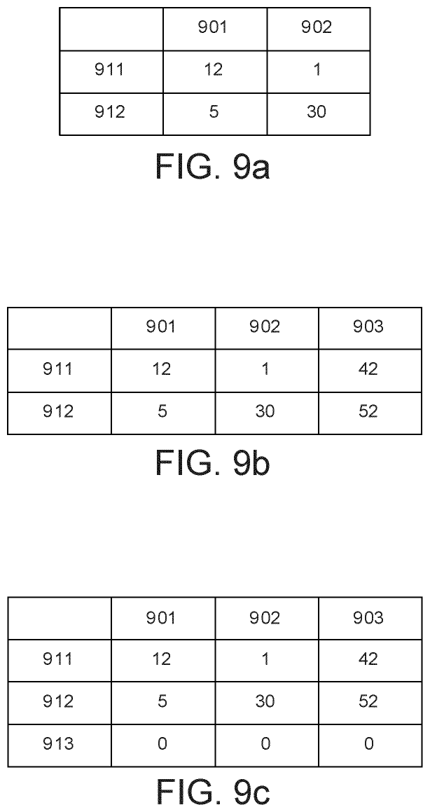

Block 640 is an update block, an embodiment of which is described in more detail in connection with FIGS. 8 and 9 illustrating methods 800, 900 that may be performed in some embodiments of block 640. Referring to FIG. 8, there is illustrated an update method 800 which may be performed in block 640 of the method 600.

Block 810 is an association block. As noted above, the OLT 600 maintains a set of any tracked objects in the environment of the vehicle 200. It will be appreciated that the set of tracked objects may, for example initially, comprise no tracked objects at some points in time. However, at many points in time, the set of tracked objects will comprise one or more tracked objects. For example, a set of one or more tracked objects in the environment of the vehicle 200 are maintained. In the association block 810 an association is determined, if possible, between tracks of the existing tracked objects and the detections of perceived objects received in block 610. Block 810 uses an association algorithm. The skilled person will be able to select an appropriate association algorithm, such as the Munkres association algorithm. The association algorithm may determine a cost between the association of each detection of a perceived object and each track to determine a lowest cost association therebetween, as will be explained in more detail below.

In some embodiments, the method 800 is arranged to determine or select one or more of the follow situations:
(a) Associate a detection of an object with an existing track, as determined in block 830 leading to blocks 840, 850;
(b) Determine that a detection is a newly detected object i.e. the object has no existing track to associate with such that a new track is created as in block 825; or
(c) Determine that a track is become stale i.e. that a track has no detection to associate with such that it is updated without a corresponding detection i.e. it is caused to degrade as in block 835.

In block 810, in some embodiments, one or more of the follow constraints may be applied:
(a) With a vehicle having more one than one sensor, multiple detections of the same object may correspond to a single track;
(b) Gating may be used to only associate a detection to a track if it is within a predetermined cost limit i.e. a detection is not associated to a track when there is one detection and one track;
(c) Association may require a lowest total cost association i.e. a lowest combined cost of all associations is determined; and/or
(d) Association may be one detection to one track, rather than multiple detections to one track or one detection to multiple tracks.

In some embodiments, a Munkres or Hungarian algorithm is utilised in block 810, although other association algorithms may be used in other embodiments.

The Munkres algorithm utilises an assignment matrix where cells intersecting rows and columns stores an assignment cost. The assignment costs represents a cost of assigning a detection to a track. A matrix traversal determines a lowest total cost i.e. unique associations having the lowest total cost. The Munkres algorithm typically utilises a square N*N assignment matrix. However in many situations there is not an equal number of detections and existing tracks. In embodiments of the invention zero-padding is used where a row or column contains less entries than its opposing side. In this way it is irrelevant to the total assignment cost. If a padded element is a detection it is treated as a new detection, or if it is a track it is treated as a ‘stale track’ as will be explained.

Referring to FIG. 9a, an assignment matrix is illustrated having columns 901, 902 corresponding to first and second detections, respectively, and rows 911, 912 corresponding to first and second tracks, respectively. A cost of association, for example, between first detection and first track is 12. The lowest assignment costs are thus Track 1, 911, =>second detection, 902, having a cost of 1 and Track 2, 912, =>first detection, 901, having a cost of 1. The total association cost is 6. The alternate association cost would be 42 (12+30).

FIG. 9b illustrates an example with three detections 901, 902, 903 and two tracks 911, 912. As discussed above, an even sided matrix is required and thus a third track 913 is introduced with zero association cost elements as in FIG. 9c. The associations for the first and second tracks 911, 912 are the same as for FIG. 9a i.e. it has no effect on the other tracks. However the new detection 903 is counted as ‘New detection’ since Track3 913 didn't exist previously. This holds true for the reverse; if there were less detections than tracks the output would be the same two associations and a ‘stale track’ i.e. without a corresponding detection. The described process works for any number of detections against tracks.

In some embodiments, gating may be used to ensure that a cost of association in a cell is less than a predetermined gating threshold. If the cost of association between a track and a detection is equal to or greater than the gating threshold or limit, then the association is removed. In this case, a track becomes a stale track i.e. not associated with a detection, or the detection is a new detection i.e. not associated with an existing track. In some embodiments the cost may be a distance, such as in meters, between a track and a detection. For example, where an association cost is 150 corresponding to a distance of 150 m, it is apparent that this is a different object than previously associated with the track.

In an example, there is a track from a front facing vehicle sensor and a detection is received from a rear facing sensor. Where there is only one track the solution is Track1->Detection1, which is incorrect when the distance is 150 m. To solve this problem, the cost gating is used, where if this cost is too great it is likely that these are unrelated. In an embodiment the gating limit is 5 meters. In this case Track1 becomes a stale track (there was no incoming detection related to it) and Detection1 becomes a New Detection, which will later have a track created for it as will be explained.

In some embodiments, the association cost is determined as a distance, as noted above, which may be a Euclidian distance between the centre of a track and the centre of a received detection. However other costs may be used. A cost function may be used to allow a variety of other methods of determining the association cost. In some embodiments, the cost function may produce the N*N matrix of cost values discussed above. In some embodiments the cost function utilises the Euclidian distance of position and Euclidian distance of two-dimensional velocity to determine the association cost. In some embodiments, a classification associated with the object may be used to determine the association cost.

In block 820 it is determined whether the OLT 600 currently tracks one or more objects i.e. whether the data store is indicative of at least one currently tracked object. If not, the method follows path 821 to block 825. If at least one object in the environment of the vehicle is being tracked, the method 800 follows path 822 to block 830.

In block 825, one or more new tracks are created in dependence on detections of perceived objects. Each perceived object received in block 610 represents a new object and is used to create a corresponding new track, with attributes of the perceived object such as location being used to initialise a state of the respective new track. An initial confidence value may be associated with the newly initialised track.

Blocks 830-850 are performed for each track in the data store of the OLT 600. In block 830 it is determined whether there is an association of a respective track to a detection of a perceived object. If not, then the track is considered stale i.e. no object has currently been detected corresponding to the track. Thus, in block 835, the track is allowed to degrade i.e. to have reduced confidence of corresponding to an object in the environment. Degrading the track in some embodiments corresponds to updating the track without an associated detection.

When the association block 810 determines a stale track, i.e. a track not associated with a detection of a perceived object to update the track, block 835 may reduce a confidence associated with the track. Reducing the confidence accelerates the track degrading and eventually being removed from the OLT 600. In some embodiments, in the predict block 620 a confidence associated with all tracks may be reduced and a further reduction may be used in block 835 to accelerate the degradation when the track is not associated with a detection of an object.

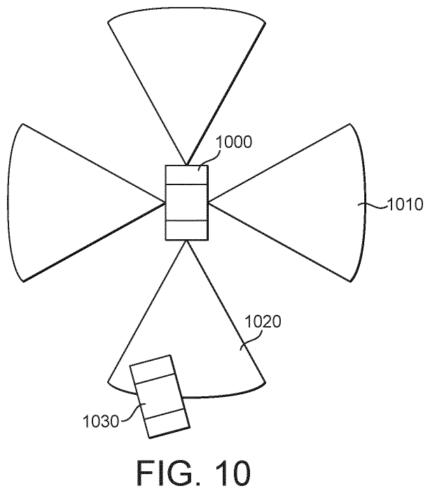

However, in some instances, where a vehicle 200 is associated with a plurality of sensors 160, 170 where at least some sensors do not have overlapping fields of view (FOV), such a further reduction may be undesirable in some instances. FIG. 10 illustrates a vehicle 1000 performing an embodiment of the method having a plurality of associated sensors each with a respective FOV, where two FOVs 1010, 1020 are indicated with reference numerals. As can be appreciated a first FOV 1010 does not overlap with a second FOV 1020. An object 1030, which may be another vehicle 1030, is within the second FOV. Thus a detection of the object 1030 would not be reported by the sensor having the first FOV 1010. However, when the method 600 is performed in dependence on data from the sensor associated with the second FOV 1020, the object 1030 will be detected initially and a new track created in block 825. When the method 600 is then performed in dependence on data from the sensor having the first FOV 1010, the object 1030 will not be detected. In this instance further degrading the confidence of the track of the object 1030 is undesirable since the first FOV 1010 would not be expected to detect the object 1030. Therefore, in some embodiments, reducing the confidence of stale tracks in block 640 may be performed in dependence on the FOV of each sensor in relation to a location of the object corresponding to the track.

If, however, there is a detection of a perceived object corresponding to the selected track as determined in block 810, the method moves to block 840. In block 840 an estimated state of the tracked object is updated i.e. the state estimator, such as the particle filer, is updated for the selected track.

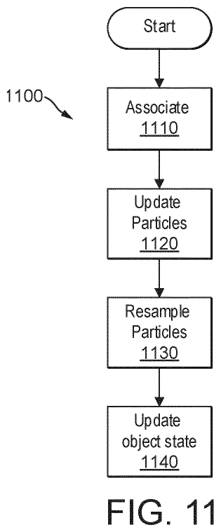

As discussed above, block 810 determines, if possible, an association between detections of perceived objects and existing tracks. In this situation, the block 840 updates a state of the tracked object in dependence on the detection of the perceived object. An embodiment of the block 840 is explained in more detail with reference to a method 1100 illustrated in FIG. 11.

Referring to FIG. 11, a method 1100 of updating the estimated state of a tracked object according to an embodiment of the invention is illustrated which is performed in block 840. The method 1100 determines a state of a tracked object, such as the object 710 shown in FIG. 7 which may correspond to another vehicle for example, in dependence on a respective particle filter associated with the tracked object. That is, for each tracked object a separate or respective particle filter is used to maintain the state of the tracked object. The particle filter is lightweight, thus enabling efficient maintenance of the state of the tracked object. The lightweight nature of the particle filter arises from the fact that the particle filter is not utilised with a grid map of a plurality of cells, as described above in connection with FIG. 4, but instead only one cell is used with the particle filter. The one cell may represent a geometry or size i.e. dimensions of the tracked object, such as dimensions of the tracked vehicle. The cell of the tracked object thus forms a bounding box for the object Furthermore, fewer particles may be used to model the track than in relation to the occupancy grid map 300 described above. A reduced number of particles improves computation performance, but at the expense of state estimation accuracy. Therefore the number of particles may be chosen appropriately. As will be explained, particles may have states of associated and un-associated with detections of perceived objects as discussed above in relation to FIG. 7.

Referring again to FIG. 7, there is illustrated a tracked object 710 such as a vehicle, although other types of objects may be tracked such as pedestrians, cyclists etc. A plurality of particles 720, 730 are also illustrated. A first plurality of particles 720 are associated with the object 710 and a second plurality of particles 730 are shown which are not associated with the object 710 i.e. are un-associated particles. As discussed above, in FIG. 7c a position or location of the object 710 is predicted in dependence on the associated particles 720 i.e. those particles having identifiers or labels associated with the object 710.

FIG. 7d illustrates the predicted location of the object 710 and a location of the perceived object 740 associated with the track, as described above. As can be appreciated, the location of the perceived object 740 is close to, but not exactly corresponding to, the predicted location of the tracked object 710.

Block 1110 of the method 1100 is an association block. In block 1120, a probability of the particles 1020, 1030 being associated with the perceived object 740 are updated. In one embodiment, particles located outside a boundary or bounding box of the perceived object 740 are de-associated, such as particle 750 (shown in FIG. 7e), whereas particles inside the boundary of the perceived object 740 are newly associated. An association of some particles may be unchanged i.e. some particles previously associated remain associated. It will be appreciated that each particle may be associated with a probability value indicative of a probability of the respective particle being associated with the perceived object and, as such the probability value may be adjusted accordingly in block 1120.

In some embodiments, particles are associated with the perceived object 740 according to:

$$y = \frac{1}{s \sqrt{( 2 π )}} exp ( - 0.5 \frac{{( x - m )}^{2}}{{s}^{2}} )$$

Where y is indicative of the probability of particle being associated with the object which may be referred to as association_prob as discussed below, mean (m) may be 0, sigma(s) may be 1 and x is the distance in meters from the particle to the detection of the perceived object. Thus, for particles within the cell of the particle filter, the probability y of the particles being associated with a detection is determined in block 1120. Effectively, particles that are within the cell, these have a very high (~1.0, in some embodiments) probability of being associated, and particles outside the cell a probability of being associated that is proportional to their respective distance from the centre-point of the cell.

In block 1110 an occupancy of the cell of the particle filter is predicted. Using the lightweight particle filter, only a single cell represents the object 710. A Basic Belief Assignment (BBA) from Dempster-Schafer Theory is maintained which represents a belief that the object 710 exists and will form a confidence value for the object. A predicted_occupancy_mass represents the likelihood that the object exists, and predicted_free_mass, that represents the likelihood that the object does not exist are maintained in some embodiments of block 1120. These masses may be calculated for the object 710 using the weights of particles 720 associated with the object. The BBA is determined as the prior mass, which can be used to determine the posterior calculated mass. It will be appreciated that this is similar to block 460 described above in connection with FIG. 4, other than there is now only one ‘cell’ defining a bounding box of the track i.e. representing the object.

The persistent mass pers_mass may be calculated, as in block 460, in some embodiments as:

$$pers\_mass = occupied\_mass - born\_mass$$

In block 1120 particles may be updated, or modified, in dependence on the detections of perceived objects. A likelihood function may be defined that calculates the Doppler measurement likelihood according to the method from DOGMa Thesis (Nuss, 2017) (equation 5.70 and 5.71 pp. 77) as in block 470. This is a determination of the likelihood of a particle existing relative to an incoming detection of a perceived object. i.e. if a particle is close to the detection, and has a similar velocity, then the particle will be given a greater weight.

Furthermore, in block 1120 an occupancy for the cell representing the tracked object is updated. In some embodiments, a posterior BBA for the tracked object is updated in some embodiments. The posterior BBA is updated in dependence on the BBA from the detection of the perceived object and the prior BBA for the track. The Dempster-Shafer Rule of Combination may be used to combine occupied and free masses. This is similar to that described above in connection with block 470, again except that there is only one cell representing the tracked object.

Similarly, particles are updated in some embodiments of block 1120. A function to update particle weights is used in some embodiments of block 1120. The function may carry out a vector multiplication between existing, un-normalised, weights of the particles and the Doppler measurement likelihood determined as part of block 1120. Updating particles in this way degrades the particle weights depending on how much their states differ from the detection of the perceived object.

A normalisation factor may be used for the tracked object in some embodiments. The normalisation is to normalise the weights of particles that are within the cell, or bounding box, of the object. To calculate the normalisation factor, the persistence mass for the cell may be divided by the sum of the particle weight in the cell to determine associated_particles_normalisation_factor. Persistence mass is relative to the incoming detections. In effect, this process increases particle weights for particles that are at, or close to, incoming detections from the sensors 160, 170.

In some embodiments, normalisation may be carried out on the weights vector. The normalisation may use unnormalised_weights for each particle, an associated_particles_normalisation_factor and unassociated_particles_normalisation_factor for the cell of the particle filter and association_prob indicative of a probability of association as discussed above, from the measurement grid map. This step of block 1120 determines a probability for particles in the cell to be associated with a detection. Each particle has a probability of being associated and of being un-associated, which added together may form the weight of the particle.

An association_part may be calculated by the association probability of the cell multiplied by the associated particles normalisation factor and the un-normalised weight of the particle.

associated_part=association_prob*associated_particles_normalisation_factor*unnormalised_weights (particle);

An unassociated_part may be calculated as:

$$unassociated\_part = ( 1 - association\_prob ) * unassociated\_particles \_normalisation \_factor * weights ( particle ) ;$$

where unassociated_particles_normalisation_factor is determined as persistent_mass/prior_occupied mass.

The above process may be carried out for every particle. It will be noted that the process is similar to that described above in connection with FIG. 4, except for their being only one cell.

The update process in block 1120 is carried out for particles in a track that have an associated detection.

For detections that have no corresponding track (unassociated detection from the Munkres algorithm in block 810) a new track is created with its state taken from the incoming detection and given a low confidence.

For tracks that have no corresponding detection associated with them, the update step in block 1120 is not carried out. This results in the track's particle weights being degraded in the predict block 620 and not updated again. Meaning the new state is calculated based on the predict block 620 alone. This models a degrading confidence without an incoming detection and updates the track's state based on its history. This also resolves the earlier problem, discussed with respect to FIG. 10, where sensors with multiple, different, fields of view (FOVs) 1010, 1020, cause a track to degrade when sensors with a FOV that cannot see the object 1030 do not detect it. In this situation the track will go through predict block 620 and then when a sensor that has the capability of detecting it provides an associated measurement the track will be updated. But for each sensor 160, 170 that cannot detected it due to its FOV, no action or degradation is performed.

Block 1130 is a resample block. Resampling may be performed to control a number of particles. In order to maintain a constant number of particles, new particles may be created in block 1130 and particles having a low weight may be pruned or removed.

A sampler function may be used in block 1130 to perform weighted random sampling. In some embodiments, the sampler function is used similar to block 480 described above.

New particles may be created during the resampling operation in block 1130. In some embodiments, the creating of particles may be controlled by parameters new_particles: the number of new particles that should be created for the tracked object, which may be proportional to the born_mass which is associated with a confidence associated with the detection of the perceived object.

Where the born_mass is higher, the larger number of particles will be created. Since born_mass is relative to the incoming detection, this results in more particles being created. These particles are created with a position and velocity strategy.

The velocity strategy may comprise instantiating particles having a velocity determined based on a velocity associated with the detection of the perceived object, rather than for example a random velocity. In one embodiment, particles may have a velocity distribution centred on the velocity of the object. Furthermore, the position strategy may position particles distributed around the cell of the particle filter.

The creation of new particles may provide a vector of new particles. New particles may be appended to existing particles i.e. the vector of new particles appended to the vector of existing particles. In some embodiments, the created joint vector of particles is resampled, such as using the sampler function noted above. In this way, new particles are created for the particle filter and, at the same time, low-weight particles are pruned so that the total number of particles is maintained at the defined limit. In block 1140 a state of the object is updated. In some embodiments, the state of the tracked object is updated in dependence on particles which are within the cell or bounding box corresponding to the tracked object. A confidence associated with the object may be determined as:

$$confidence = occupied\_mass + 0.5 * ( 1 - occupied\_mass - free\_mass )$$

In some embodiments, a position an velocity of the object may be determined in dependence on an average position and velocity of the associated particles. In some embodiments, particle weight may be used such that particles having a higher weight may influence the position and velocity of the object more.

Returning to FIG. 8, in block 850 an indication of a classification i.e. indicative of a type of the object provided by each sensor 160, 170 or source is fused or combined. The classification may be determined in dependence on a plurality of different types of object, such as car, truck (wagon, HGV), pedestrian and unknown. For example, a sensor may indicate that a detection is {car: 70%, truck: 15%, pedestrian 10% and unknown 5%}. The sum of classifications totals 100%. It will be appreciated that this list of potential types of object is merely illustrative. If different sensors 160, 170 of the system support different sets of classification, then these may be pre-processed to utilise a shared classification set. The classifications from a plurality of sensors may be combined or fused using Dempster-Schafer combination, as will be appreciated.

Returning to FIG. 6, in block 660 data indicative of a state one or more tracked objects is output. The data may be referred to as tracked object data. The tracked object data may be indicative of, for each tracked object, one or more of a location, velocity, direction and classification of the respective tracked object. The tracked object data may be used for the robot, such as the vehicle, to perform one or more functions in dependence thereon. For example, the tracked object data to control movement of the robot or vehicle in dependence thereon. For example, an application to torque (negative or positive) and steering of the vehicle may be controlled in dependence on the tracked object data such that the tracked object is avoided. Other uses of the tracked object data may be envisaged e.g. to provide an indication of the tracked object to an occupant of the vehicle in dependence thereon.

1. A control system for a vehicle, the control system comprising at least one controller, the control system being configured to:
receive, from at least one sensor, sensor data indicative of a location of objects detected in an environment of the vehicle;
determine, in dependence on the sensor data, an occupancy grid stored in a memory accessible to the control system, and a particle filter associated with the occupancy grid, the particle filter maintaining a plurality of particles indicative of a state of the occupancy grid;
associate one or more groups of particles within the plurality of particles, wherein each group of associated particles is representative of a perceived object in the environment of the vehicle;
maintain a set of one or more tracked objects in the environment of the vehicle in dependence on the one or more perceived objects;
determine a state of each of the one or more tracked objects in dependence on a respective particle filter associated with each of the one or more tracked objects; and
output data indicative of the state of the one or more tracked objects.

2. The control system of claim 1, wherein the control system is configured to receive, in dependence on at least one sensor system, perceived object data indicative of one or more perceived objects in the environment of the vehicle,
wherein the maintaining the set of one or more tracked objects in the environment of the vehicle is in dependence on the perceived object data, and optionally,
wherein the perceived object data is indicative of, for each perceived object, a classification and a location of the respective object in the environment of the vehicle.

3. The control system of claim 1, wherein the associating the one or more groups of particles comprises determining one or more clusters of particles within the plurality of particles according to one or more predetermined criteria, and optionally,
wherein the one or more criteria comprise a maximum distance criteria indicative of a maximum distance between particles to form a respective cluster of particles and/or the one or more criteria comprise a minimum particle criteria indicative of a minimum number of particles to form a respective cluster of particles.

4. The control system of claim 1, wherein the associating the particles of each of the one or more groups of particles comprises updating an attribute of each of the particles to a shared attribute.

5. The control system of claim 1, wherein the maintaining the set of one or more tracked objects comprises the control system being configured to determine whether each of the perceived objects corresponds to one of the set of tracked objects or represents a new object.

6. The control system of claim 1, wherein the determining the state of each of the one or more tracked objects comprises the control system being configured to predict a state of each of the one or more tracked objects and to combine each tracked object with a respective perceived object.

7. The control system of claim 1, wherein the determining the state of each of the one or more tracked objects comprises the control system being configured to, for at least some of the one or more tracked objects, predict at least one of an occupancy mass and a free mass for each tracked object in dependence on a weight of particles of the particle filter associated with the respective tracked object.

8. The control system of claim 7, wherein each of the one or more tracked objects is associated with a bounding box and the control system is configured to predict the at least one of the occupancy mass and the free mass for each tracked object in dependence on the weight of particles of the particle filter within the bounding box.

9. A system, comprising:
a control system according to claim 1; and
at least one sensor arranged to provide to the control system sensor data indicative of a location of objects detected in an environment of the vehicle to the control system.

10. The system of claim 9, wherein the at least one sensor is arranged to provide sensor data comprising point cloud data indicative of the location of a detection of objects in an environment of the vehicle to the control system.

11. The system of claim 9, further comprising a sensor system arranged to provide perceived object data indicative of one or more perceived objects in the environment of the vehicle to the control system.

12. The system of claim 11, wherein the sensor system comprises a vision system arranged to determine a classification of each perceived object, and
wherein the perceived object data is indicative of the determined classification.

13. A vehicle comprising the control system of claim 1.

14. A method, comprising:
receiving, from at least one sensor, sensor data indicative of a location of objects detected in an environment of the vehicle;
determining, in dependence on the sensor data, an occupancy grid stored in a memory accessible to the control system, and a particle filter associated with the occupancy grid, the particle filter maintaining a plurality of particles indicative of a state of the occupancy grid;
associating one or more groups of particles within the plurality of particles, wherein each group of associated particles is representative of a perceived object in the environment of the vehicle;
maintaining a set of one or more tracked objects in the environment of the vehicle in dependence on the one or more perceived objects;
determining a state of each of the one or more tracked objects in dependence on a respective particle filter associated with each of the one or more tracked objects; and
outputting data indicative of the state of the one or more tracked objects.

15. The method of claim 14, wherein the method is performed by computer software that is executed by a computer, and optionally,
wherein the computer software is stored on a non-transitory computer readable storage medium.

16. A vehicle comprising the system of claim 9.
